(19) United States
(12) Patent Application Publication
(10) Pub. No.: US 2010/0128803 A1
(43) Pub. Date: May 27, 2010

(54) METHODS AND APPARATUS FOR IN-LOOP DE-ARTIFACTING FILTERING BASED ON MULTI-LATTICE SPARSITY-BASED FILTERING

(76) Inventors: Oscar Divorra Escoda, Barcelona (ES); Peng Yin, Plainsboro, NJ (US)

Correspondence Address: Robert D. Shedd, Patent Operations;THOMSON Licensing LLC, P.O. Box 5312, Princeton, NJ, 08543-5312, US

(21) Appl. No.: 12/451,856

(22) PCT Filed: Jun. 3, 2008
(86) PCT No.: PCT/US2008/006971

§ 371 Date: Dec. 3, 2009

(51) Int. Cl. H04B 1/66

(52) U.S. Cl. 375/240.29; 382/264; 375/E07.194

(57) ABSTRACT

There are provided methods and apparatus for in-loop de-artifact filtering based on multi-lattice sparsity-based filtering. An apparatus includes an encoder for encoding picture data for a picture. The encoder includes an in-loop de-artifacting filter for de-artifacting the picture data to output an adaptive weighted combination of at least two filtered versions of the picture. The picture data includes at least one sub-sampling of the picture.

### CROSS-REFERENCE TO RELATED APPLICATIONS

This application claims the benefit of U.S. Provisional Application Ser. No. 60/942,686, filed 8 June, 2007, which is incorporated by reference herein in its entirety.

### TECHNICAL FIELD

The present principles relate generally to video encoding and decoding and, more particularly, to methods and apparatus for in-loop de-artifacting filtering based on multi-lattice sparsity-based filtering.

### BACKGROUND

The International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”) is currently the most efficient and state-of-the-art video coding standard. Similar to other video coding standards, the MPEG-4 AVC Standard employs block-based Discrete Cosine Transforms (DCTs) and motion compensation. Coarse quantization of the transform coefficients can cause various visually disturbing artifacts, such as blocky artifacts, edge artifacts, texture artifacts, and so forth. The MPEG-4 AVC Standard defines an adaptive in-loop deblocking filter to solve the issue, but the filter only focuses on smoothing blocky edges. The filter does not try to correct other artifacts caused by quantization noises, such as distorted edges and texture.

All video compression artifacts result from quantization, which is the only lossy coding part in a hybrid video coding framework. However, those artifacts can be present in various forms including, but not limited to, blocking artifacts, ringing artifacts, edge distortion, and texture corruption. In general, the decoded sequence may be composed of all types of visual artifacts, but with different severances. Among the different types of visual artifacts, blocky artifacts are common in block-based video coding. These artifacts can originate from both the transform stage (e.g., DCT or MPEG-4 AVC Standard integer block transforms) in residue coding and from the prediction stage (e.g., motion compensation and/or intra prediction). Adaptive deblocking filters have been studied in the past and some well-known methods have been proposed, for example, as in the MPEG-4 AVC standard. When designed well, adaptive deblocking filters can improve both objective and subjective video quality. In state of the art video codecs, such as in the MPEG-4 AVC Standard, an adaptive in-loop deblocking filter is designed to reduce blocky artifacts, where the strength of filtering is controlled by the values of several syntax elements, as well as by the local amplitude and structure of the reconstructed image. The basic idea is that if a relatively large absolute difference between samples near a block edge is measured, it is quite likely a blocking artifact and should therefore be reduced. However, if the magnitude of that difference is so large that it cannot be explained by the coarseness of the quantization used in the encoding, the edge is more likely to reflect the actual behavior of the source picture and should not be smoothed over. In this way, the blockiness is reduced, while the sharpness of the content is basically unchanged. The deblocking filter is adaptive on several levels. On the slice level, the global filtering strength can be adjusted to the individual characteristics of the video sequence. On the block-edge level, filtering strength is made dependent on the inter/intra prediction decision, motion differences, and the presence of coded residuals in the two neighboring blocks. On macroblock boundaries, special strong filtering is applied to remove “tiling artifacts”. On the sample level, sample values and quantizer-dependent thresholds can turn off filtering for each individual sample.

The MPEG-4 AVC Standard deblocking filter is well designed to reduce blocky artifacts, but does not try to correct other artifacts caused by quantization noise. For example, the MPEG-4 AVC Standard deblocking filter leaves edges and textures untouched. Thus, the MPEG-4 AVC Standard cannot improve any distorted edge or texture. One reason behind this is that the MPEG-4 AVC Standard deblocking filter applies a smooth image model and the designed filters typically include a bank of low-pass filters. However, images may include many singularities, textures, and so forth, which are not handled correctly by the MPEG-4 AVC Standard deblocking filter.

In order to overcome the limitations of the MPEG-4 AVC Standard deblocking filter, a denoising type nonlinear in-loop filter has recently been proposed in a first prior art approach. The first prior art approach describes a nonlinear denoising filter that adapts to non-stationary image statistics exploiting a sparse image model using an overcomplete set of linear transforms and a thresholding operation. The nonlinear denoising filter of the first prior art approach automatically becomes high-pass, or low-pass, or band-pass, and so forth, depending on the region it is operating on. The nonlinear denoising filter of the first prior art approach can combat all types of quantization noise.

The denoising basically includes the following three steps: transform; thresholding; and inverse transform. Then several denoised estimates provided by denoising with an overcomplete set of transforms (e.g., in the first prior art approach, produced by applying denoising with shifted versions of the same transform) are combined by weighted averaging them at every pixel. The adaptive in-loop filtering described in the first prior art approach is based on the use of redundant transforms. The redundant transforms are generated by all the possible translations Hᵢ of a given transform H. Hence, given an image I, a series of different transformed versions Yᵢ of the image I are generated by applying the transforms Hᵢ on I. Every transformed version Yᵢ is then processed by means of a coefficients denoising procedure (usually a thresholding operation) in order to reduce the noise included in the transformed coefficients. This generates a series of Y′ᵢ. After that, each Y′ᵢ is transformed back into the spatial domain becoming different estimates I′ᵢ, where there should be, in each of them, a lower amount of noise. The first prior art approach also exploits the fact that the different I′ᵢ include the best denoised version of I for different locations. Hence, the first prior art approach estimates the final filtered version I′ as a weighted sum of I′ᵢ where the weights are optimized such that the best I′ᵢ is favored at every location of I′. FIGS. 1 and 2 relate to this first prior art approach.

Turning to FIG. 1, an apparatus for position adaptive sparsity based filtering of pictures in accordance with the prior art is indicated generally by the reference numeral 100.

The apparatus 100 includes a first transform module (with transform matrix 1) 105 having an output connected in signal communication with an input of a first denoise coefficients module 120. An output of the first denoise coefficients module 120 is connected in signal communication with an input of a first inverse transform module (with inverse transform matrix 1) 135, an input of a combination weights computation module 150, and an input of an Nth inverse transform module (with inverse transform matrix N) 145. An output of the first inverse transform module (with inverse transform matrix 1) 135 is connected in signal communication with a first input of a combiner 155.

An output of a second transform module (with transform matrix 2) 110 is connected in signal communication with an input of a second denoise coefficients module 125. An output of the second denoise coefficients module 125 is connected in signal communication with an input of a second inverse transform module (with inverse transform matrix 2) 140, the input of the combination weights computation module 150, and the input of the Nth inverse transform module (with inverse transform matrix N) 145. An output of the second inverse transform module (with inverse transform matrix 2) 140 is connected in signal communication with a second input of the combiner 155.

An output of an Nth transform module (with transform matrix N) 115 is connected in signal communication with an input of an Nth denoise coefficients module 130. An output of the Nth denoise coefficients module 130 is connected in signal communication with an input of the Nth inverse transform module (with inverse transform matrix N) 145, the input of the combination weights computation module 150, and the input of the first inverse transform module (with inverse transform matrix 1) 135. An output of the Nth inverse transform module (with inverse transform matrix N) 145 is connected in signal communication with a third input of the combiner 155.

An output of the combination weight computation module 150 is connected in signal communication with a fourth input of the combiner 155.

An input of the first transform module (with transform matrix 1) 105, an input of the second transform module (with transform matrix 2) 110, and an input of the Nth transform module (with transform matrix N) 115 are available as inputs of the apparatus 100, for receiving an input image. An output of the combiner 155 is available as an output of the apparatus 100, for providing an output image.

Turning to FIG. 2, a method for position adaptive sparsity based filtering of pictures in accordance with the prior art is indicated generally by the reference numeral 200.

The method 200 includes a start block 205 that passes control to a loop limit block 210. The loop limit block 210 performs a loop for every value of variable i, and passes control to a function block 215. The function block 215 performs a transformation with transform matrix i, and passes control to a function block 220. The function block 220 determines the denoise coefficients, and passes control to a function block 225. The function block 225 performs an inverse transformation with inverse transform matrix i, and passes control to a loop limit block 230. The loop limit block 230 ends the loop over each value of variable i, and passes control to a function block 235. The function block 235 combines (e.g., locally adaptive weighted sum of) the different inverse transformed versions of the denoised coefficients images, and passes control to an end block 299.

Weighting approaches can be various and may depend at least on at least one of the following: the data to be filtered; the transforms used on the data; and statistical assumptions on the noise/distortion to filter.

The first prior art approach considers each Hᵢ an orthonormal transform. Moreover, the first prior art approach considers each Hᵢ to be a translated version of a given 2D orthonormal transform, such as wavelets or DCT. Taking this into account, the MPEG-4 AVC Standard does not consider the fact that a given orthonormal transform has a limited amount of directions of analysis. Hence, even if all possible translations of the DCT are used to generate an over-complete representation of I, I will be decomposed uniquely into vertical and horizontal components, independent of the particular components of I.

Sparsity based denoising tools could reduce quantization noise over video frames composed of locally uniform regions (smooth, high frequency, texture, and so forth) separated by singularities. However, as noted extensively in the first prior art approach, the denoising tool thereof was initially designed for additive, independent and identically distributed (i.i.d.) noise removal, but quantization noise has significantly different properties, which can present issues in terms of proper distortion reduction and visual de-artifacting. This implies that these techniques may get confused by true edges or false blocky edges. While it may be argued that spatio-frequential threshold adaptation may be able to correct the decision, such an implementation of the same would not be trivial. A possible consequence of inadequate threshold selection is that sparse denoising might result into over-smoothed reconstructed pictures or blocky artifacts may still be present despite the filtering procedure. At present, as observed in our experiments, the sparsity based denoising technique presented in the first prior art approach, when applied instead of the in-loop filtering step in the MPEG-4 AVC Standard, even though it presents a higher distortion reduction in terms of objective measures (e.g., mean square error (MSE)) than other techniques, it still presents important visual artifacts that need to be addressed.

A first of at least two reasons for this deficiency in the first prior art approach is that the transform used in the filtering step is closely similar (or equal) to the transform used to code the residual. Since the quantization error introduced into the coded signal is sometimes under the form of a reduction of the number of coefficients available for reconstruction, this reduction of coefficients confuses the measure of signal sparsity performed in the generation of weights in the first prior art approach. This makes quantization noise affect the weights generation, which then affects the proper weighting of the best I′ᵢ in some locations, making still visible some blocky artifacts after filtering.

A second of at least two reasons for this deficiency in the first prior art approach is that the use in the first prior art approach of a single type of orthogonal transforms like the DCT with all of its translations has a limited amount of principal directions for the structural analysis (i.e., vertical and horizontal). This impairs proper de-artifacting of signal structures with neither vertical nor horizontal orientation.

Other approaches have been proposed for compression artifact reduction based on projection onto convex sets (POCS). However, such approaches are computationally intensive, and do not necessarily address all the artifacts listed above. A second prior art approach computes signal adapted sub-spaces, but is not able to completely remove all blocking artifacts since the second prior art approach does not properly deal with high frequency components of the signal. In a third prior art approach, it is proposed to use wavelet transforms and thresholding for processing and denoising reconstructed compressed images. However, the third prior art approach is still limited in the sense that the third prior art approach does not properly process highly textured areas, is not able to properly de-artifact geometric distortion on edges and is also limited in the treatment of oriented features.

Turning to FIG. 3, a video encoder capable of performing video encoding in accordance with the MPEG-4 AVC standard is indicated generally by the reference numeral 300.

The video encoder 300 includes a frame ordering buffer 310 having an output in signal communication with a non-inverting input of a combiner 385. An output of the combiner 385 is connected in signal communication with a first input of a transformer and quantizer 325. An output of the transformer and quantizer 325 is connected in signal communication with a first input of an entropy coder 345 and a first input of an inverse transformer and inverse quantizer 350. An output of the entropy coder 345 is connected in signal communication with a first non-inverting input of a combiner 390. An output of the combiner 390 is connected in signal communication with a first input of an output buffer 335.

A first output of an encoder controller 305 is connected in signal communication with a second input of the frame ordering buffer 310, a second input of the inverse transformer and inverse quantizer 350, an input of a picture-type decision module 315, an input of a macroblock-type (MB-type) decision module 320, a second input of an intra prediction module 360, a second input of a deblocking filter 365, a first input of a motion compensator 370, a first input of a motion estimator 375, and a second input of a reference picture buffer 380.

A second output of the encoder controller 305 is connected in signal communication with a first input of a Supplemental Enhancement Information (SEI) inserter 330, a second input of the transformer and quantizer 325, a second input of the entropy coder 345, a second input of the output buffer 335, and an input of the Sequence Parameter Set (SPS) and Picture Parameter Set (PPS) inserter 340.

A first output of the picture-type decision module 315 is connected in signal communication with a third input of a frame ordering buffer 310. A second output of the picture-type decision module 315 is connected in signal communication with a second input of a macroblock-type decision module 320.

An output of the Sequence Parameter Set (SPS) and Picture Parameter Set (PPS) inserter 340 is connected in signal communication with a third non-inverting input of the combiner 390.

An output of the inverse quantizer and inverse transformer 350 is connected in signal communication with a first non-inverting input of a combiner 327. An output of the combiner 327 is connected in signal communication with a first input of the intra prediction module 360 and a first input of the deblocking filter 365. An output of the deblocking filter 365 is connected in signal communication with a first input of a reference picture buffer 380. An output of the reference picture buffer 380 is connected in signal communication with a second input of the motion estimator 375. A first output of the motion estimator 375 is connected in signal communication with a second input of the motion compensator 370. A second output of the motion estimator 375 is connected in signal communication with a third input of the entropy coder 345.

An output of the motion compensator 370 is connected in signal communication with a first input of a switch 397. An output of the intra prediction module 360 is connected in signal communication with a second input of the switch 397. An output of the macroblock-type decision module 320 is connected in signal communication with a third input of the switch 397. An output of the switch 397 is connected in signal communication with a second non-inverting input of the combiner 327.

Inputs of the frame ordering buffer 310 and the encoder controller 805 are available as input of the encoder 300, for receiving an input picture 301. Moreover, an input of the Supplemental Enhancement Information (SEI) inserter 330 is available as an input of the encoder 300, for receiving metadata. An output of the output buffer 335 is available as an output of the encoder 300, for outputting a bitstream.

Turning to FIG. 4, a video decoder capable of performing video decoding in accordance with the MPEG-4 AVC standard is indicated generally by the reference numeral 400.

The video decoder 400 includes an input buffer 410 having an output connected in signal communication with a first input of an entropy decoder 445. A first output of the entropy decoder 445 is connected in signal communication with a first input of an inverse transformer and inverse quantizer 450. An output of the inverse transformer and inverse quantizer 450 is connected in signal communication with a second non-inverting input of a combiner 425. An output of the combiner 425 is connected in signal communication with a second input of a deblocking filter 465 and a first input of an intra prediction module 460. A second output of the deblocking filter 465 is connected in signal communication with a first input of a reference picture buffer 480. An output of the reference picture buffer 480 is connected in signal communication with a second input of a motion compensator 470.

A second output of the entropy decoder 445 is connected in signal communication with a third input of the motion compensator 470 and a first input of the deblocking filter 465. A third output of the entropy decoder 445 is connected in signal communication with an input of a decoder controller 405. A first output of the decoder controller 405 is connected in signal communication with a second input of the entropy decoder 445. A second output of the decoder controller 405 is connected in signal communication with a second input of the inverse transformer and inverse quantizer 450. A third output of the decoder controller 405 is connected in signal communication with a third input of the deblocking filter 465. A fourth output of the decoder controller 405 is connected in signal communication with a second input of the intra prediction module 460, with a first input of the motion compensator 470, and with a second input of the reference picture buffer 480.

An output of the motion compensator 470 is connected in signal communication with a first input of a switch 497. An output of the intra prediction module 460 is connected in signal communication with a second input of the switch 497. An output of the switch 497 is connected in signal communication with a first non-inverting input of the combiner 425.

An input of the input buffer 410 is available as an input of the decoder 400, for receiving an input bitstream. A first output of the deblocking filter 465 is available as an output of the decoder 400, for outputting an output picture.

### SUMMARY

These and other drawbacks and disadvantages of the prior art are addressed by the present principles, which are directed to methods and apparatus for in-loop de-artifacting filtering based on multi-lattice sparsity-based filtering.

According to an aspect of the present principles, there is provided an apparatus. The apparatus includes an encoder for encoding picture data for a picture. The encoder includes an in-loop de-artifacting filter for de-artifacting the picture data to output an adaptive weighted combination of at least two filtered versions of the picture. The picture data includes at least one sub-sampling of the picture.

According to another aspect of the present principles, there is provided a method. The method includes encoding picture data for a picture. The encoding step includes in-loop de-artifact filtering the picture data to output an adaptive weighted combination of at least two filtered versions of the picture. The picture data includes at least one sub-sampling of the picture.

According to still another aspect of the present principles, there is provided an apparatus. The apparatus includes a decoder for decoding picture data for a picture. The decoder includes an in-loop de-artifacting filter for de-artifacting the picture data to output an adaptive weighted combination of at least two filtered versions of the picture. The picture data includes at least one sub-sampling of the picture.

According to yet another aspect of the present principles, there is provided a method. The method includes decoding picture data for a picture. The decoding step includes in-loop de-artifact filtering the decoded picture data to output an adaptive weighted combination of at least two filtered versions of the picture. The picture data includes at least one sub-sampling of the picture.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram for an apparatus for position adaptive sparsity based filtering of pictures, in accordance with the prior art;

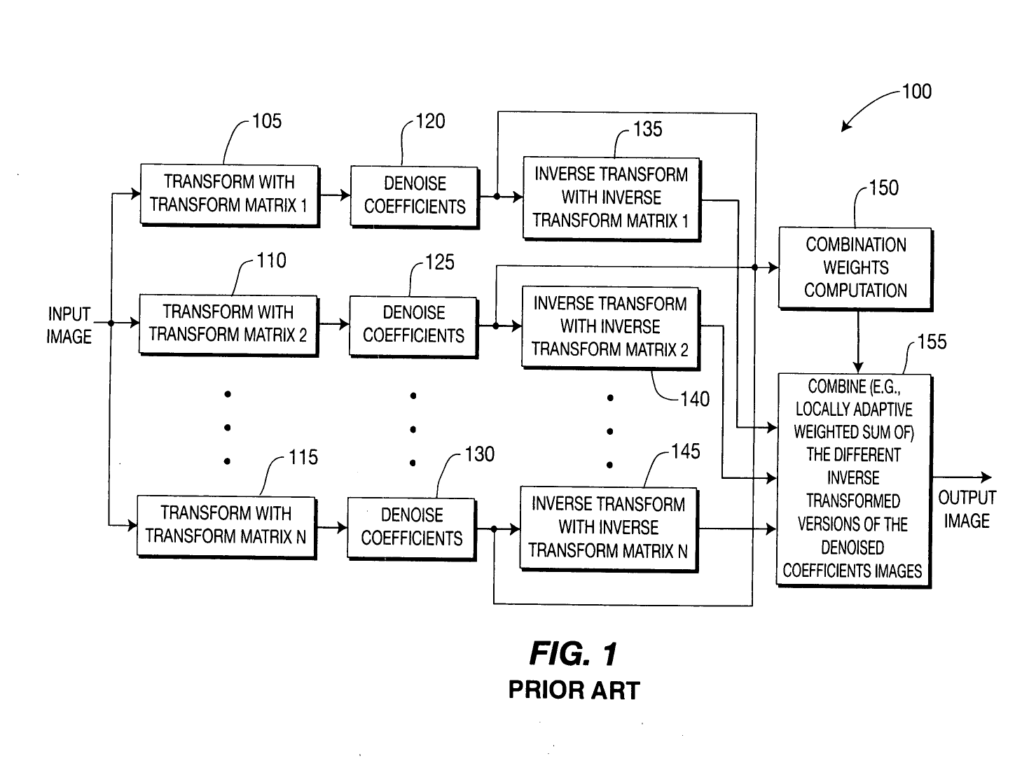

FIG. 2 is a flow diagram for a method for position adaptive sparsity based filtering of pictures, in accordance with the prior art;

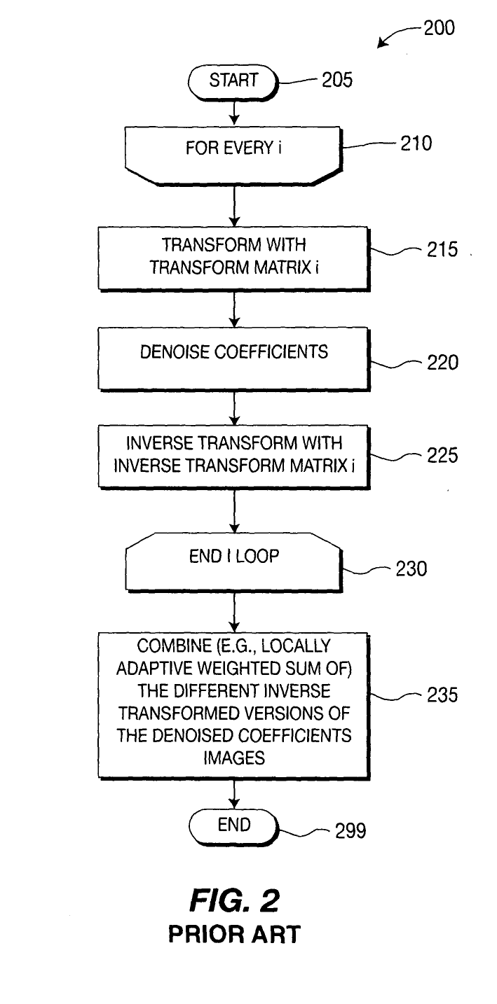

FIG. 3 shows a block diagram for a video encoder capable of performing video encoding in accordance with the MPEG-4 AVC Standard;

FIG. 4 shows a block diagram for a video decoder capable of performing video decoding in accordance with the MPEG-4 AVC Standard;

FIG. 5 shows a block diagram for a video encoder capable of performing video encoding in accordance with the MPEG-4 AVC Standard, extended for use with the present principles, according to an embodiment of the present principles;

FIG. 6 shows a block diagram for a video decoder capable of performing video decoding in accordance with the MPEG-4 AVC Standard, extended for use with the present principles, according to an embodiment of the present principles;

FIG. 7 is a high-level block diagram for an exemplary position adaptive sparsity based filter for pictures with multi-lattice signal transforms, in accordance with an embodiment of the present principles;

FIG. 8 is a high-level block diagram for another exemplary position adaptive sparsity based filter for pictures with multi-lattice signal transforms, in accordance with an embodiment of the present principles;

FIG. 9 is a diagram for Discrete Cosine Transform (DCT) basis functions and their shapes included in a DCT of 8×8 size, to which the present principles may be applied, in accordance with an embodiment of the present principles;

FIGS. 10A and 10B are diagram showing examples of lattice sampling with corresponding lattice sampling matrices, to which the present principles may be applied, in accordance with an embodiment of the present principles;

FIG. 11 is a flow diagram for an exemplary method for position adaptive sparsity based filtering of pictures with multi-lattice signal transforms, in accordance with an embodiment of the present principles;

FIGS. 12A-12D are diagram for a respective one of four of the 16 possible translations of a 4×4 DCT transform, to which the present principles may be applied, in accordance with an embodiment of the present principles; and

FIG. 13 is a diagram for an exemplary in-loop de-artifacting filter based on multi-lattice sparsity-based filtering, in accordance with an embodiment of the present principles.

### DETAILED DESCRIPTION

The present principles are directed to methods and apparatus for in-loop de-artifacting filtering based on multi-lattice sparsity-based filtering.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

It is to be appreciated that the use of the term “and/or”, for example, in the case of “A and/or B”, is intended to encompass the selection of the first listed option (A), the selection of the second listed option (B), or the selection of both options (A and B). As a further example, in the case of “A, B, and/or C”, such phrasing is intended to encompass the selection of the first listed option (A), the selection of the second listed option (B), the selection of the third listed option (C), the selection of the first and the second listed options (A and B), the selection of the first and third listed options (A and C), the selection of the second and third listed options (B and C), or the selection of all three options (A and B and C). This may be extended, as readily apparent by one of ordinary skill in this and related arts, for as many items listed.

As used herein, the term “picture” refers to images and/or pictures including images and/or pictures relating to still and motion video.

Moreover, as used herein, the term “sparsity” refers to the case where a signal has few non-zero coefficients in the transformed domain. As an example, a signal with a transformed representation with 5 non-zero coefficients has a sparser representation than another signal with 10 non-zero coefficients using the same transformation framework.

Further, as used herein, the terms “lattice” or “lattice-based”, as used with respect to a sub-sampling of a picture, refers to a sub-sampling where samples would be selected according to a given structured pattern of spatially continuous and/or non-continuous samples. In an example, such pattern may be a geometric pattern such as a rectangular pattern.

Also, as used herein, the term “local” refers to the relationship of an item of interest (including, but not limited to, a measure of average amplitude, average noise energy or the derivation of a measure of weight), relative to pixel location level, and/or an item of interest corresponding to a pixel or a localized neighborhood of pixels within a picture.

Additionally, as used herein, the term “global” refers to the relationship of an item of interest (including, but not limited to, a measure of average amplitude, average noise energy or the derivation of a measure of weight) relative to picture level, and/or an item of interest corresponding to the totality of pixels of a picture or sequence.

Moreover, as used herein, “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, Picture Parameter Set (PPS) level, Sequence Parameter Set (SPS) level and Network Abstraction Layer (NAL) unit header level.

Further, as used herein, “block level syntax” and “block level syntax element” interchangeably refer to syntax present in the bitstream that resides hierarchically at any of the possible coding units structured as a block or a partition(s) of a block in a video coding scheme. For example, block level syntax, as used herein, may refer to, but is not limited to, syntax at the macroblock level, the 16×8 partition level, the 8×16 partition level, the 8×8 sub-block level, and general partitions of any of these. Moreover, block level syntax, as used herein, may also refer to blocks issued from the union of smaller blocks (e.g., unions of macroblocks).

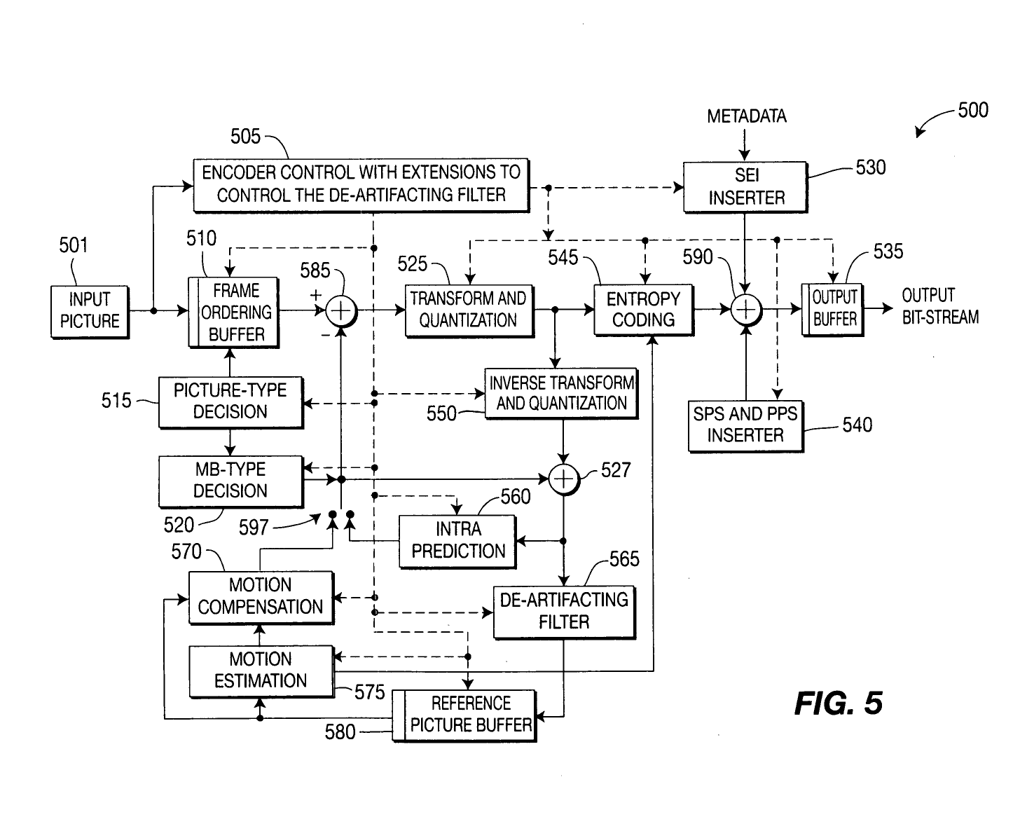

Turning to FIG. 5, a video encoder capable of performing video encoding in accordance with the MPEG-4 AVC standard, extended for use with the present principles, is indicated generally by the reference numeral 500.

The video encoder 500 includes a frame ordering buffer 510 having an output in signal communication with a non-inverting input of a combiner 585. An output of the combiner 585 is connected in signal communication with a first input of a transformer and quantizer 525. An output of the transformer and quantizer 525 is connected in signal communication with a first input of an entropy coder 545 and a first input of an inverse transformer and inverse quantizer 550. An output of the entropy coder 545 is connected in signal communication with a first non-inverting input of a combiner 590. An output of the combiner 590 is connected in signal communication with a first input of an output buffer 535.

A first output of an encoder controller with extensions (to control the de-artifacting filter 565) 505 is connected in signal communication with a second input of the frame ordering buffer 510, a second input of the inverse transformer and inverse quantizer 550, an input of a picture-type decision module 515, an input of a macroblock-type (MB-type) decision module 520, a second input of an intra prediction module 560, a second input of a de-artifacting filter 565, a first input of a motion compensator 570, a first input of a motion estimator 575, and a second input of a reference picture buffer 580.

A second output of the encoder controller with extensions (to control the de-artifacting filter 565) 505 is connected in signal communication with a first input of a Supplemental Enhancement Information (SEI) inserter 530, a second input of the transformer and quantizer 525, a second input of the entropy coder 545, a second input of the output buffer 535, and an input of the Sequence Parameter Set (SPS) and Picture Parameter Set (PPS) inserter 540.

A first output of the picture-type decision module 515 is connected in signal communication with a third input of a frame ordering buffer 510. A second output of the picture-type decision module 515 is connected in signal communication with a second input of a macroblock-type decision module 520.

An output of the Sequence Parameter Set (SPS) and Picture Parameter Set (PPS) inserter 540 is connected in signal communication with a third non-inverting input of the combiner 590.

An output of the inverse quantizer and inverse transformer 550 is connected in signal communication with a first non-inverting input of a combiner 527. An output of the combiner 527 is connected in signal communication with a first input of the intra prediction module 560 and a first input of the de-artifacting filter 565. An output of the de-artifacting filter 565 is connected in signal communication with a first input of a reference picture buffer 580. An output of the reference picture buffer 580 is connected in signal communication with a second input of the motion estimator 575. A first output of the motion estimator 575 is connected in signal communication with a second input of the motion compensator 570. A second output of the motion estimator 575 is connected in signal communication with a third input of the entropy coder 545.

An output of the motion compensator 570 is connected in signal communication with a first input of a switch 597. An output of the intra prediction module 560 is connected in signal communication with a second input of the switch 597. An output of the macroblock-type decision module 520 is connected in signal communication with a third input of the switch 597. An output of the switch 597 is connected in signal communication with a second non-inverting input of the combiner 527.

Inputs of the frame ordering buffer 510 and the encoder controller with extensions (to control the de-artifacting filter 565) 505 are available as input of the encoder 500, for receiving an input picture 501. Moreover, an input of the Supplemental Enhancement Information (SEI) inserter 530 is available as an input of the encoder 500, for receiving metadata. An output of the output buffer 535 is available as an output of the encoder 500, for outputting a bitstream.

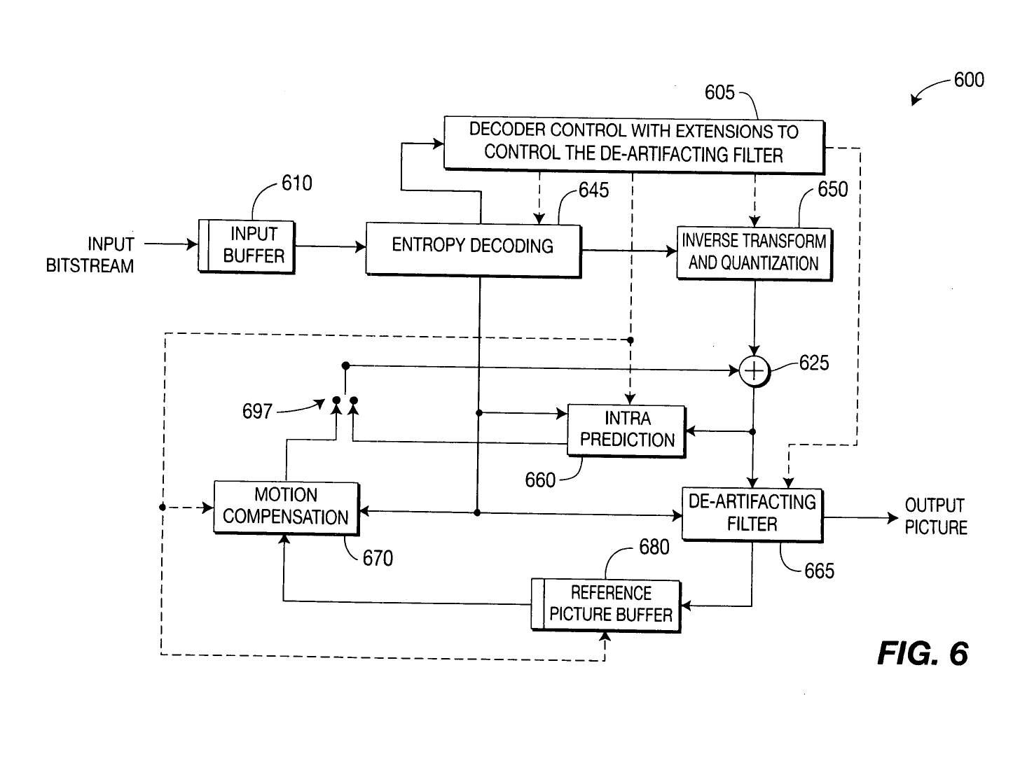

Turning to FIG. 6, a video decoder capable of performing video decoding in accordance with the MPEG-4 AVC standard, extended for use with the present principles, is indicated generally by the reference numeral 600.

The video decoder 600 includes an input buffer 610 having an output connected in signal communication with a first input of an entropy decoder 645. A first output of the entropy decoder 645 is connected in signal communication with a first input of an inverse transformer and inverse quantizer 650. An output of the inverse transformer and inverse quantizer 650 is connected in signal communication with a second non-inverting input of a combiner 625. An output of the combiner 625 is connected in signal communication with a second input of a de-artifacting filter 665 and a first input of an intra prediction module 660. A second output of the de-artifacting filter 665 is connected in signal communication with a first input of a reference picture buffer 680. An output of the reference picture buffer 680 is connected in signal communication with a second input of a motion compensator 670.

A second output of the entropy decoder 645 is connected in signal communication with a third input of the motion compensator 670 and a first input of the de-artifacting filter 665. A third output of the entropy decoder 645 is connected in signal communication with an input of a decoder controller with extensions (to control the de-artifacting filter 665) 605. A first output of the decoder controller with extensions (to control the de-artifacting filter 665) 605 is connected in signal communication with a second input of the entropy decoder 645. A second output of the decoder controller with extensions (to control the de-artifacting filter 665) 605 is connected in signal communication with a second input of the inverse transformer and inverse quantizer 650. A third output of the decoder controller with extensions (to control the de-artifacting filter 665) 605 is connected in signal communication with a third input of the de-artifacting filter 665. A fourth output of the decoder controller with extensions (to control the de-artifacting filter 665) 605 is connected in signal communication with a second input of the intra prediction module 660, with a first input of the motion compensator 670, and with a second input of the reference picture buffer 680.

An output of the motion compensator 670 is connected in signal communication with a first input of a switch 697. An output of the intra prediction module 660 is connected in signal communication with a second input of the switch 697. An output of the switch 697 is connected in signal communication with a first non-inverting input of the combiner 625.

An input of the input buffer 610 is available as an input of the decoder 600, for receiving an input bitstream. A first output of the deblocking filter 665 is available as an output of the decoder 600, for outputting an output picture.

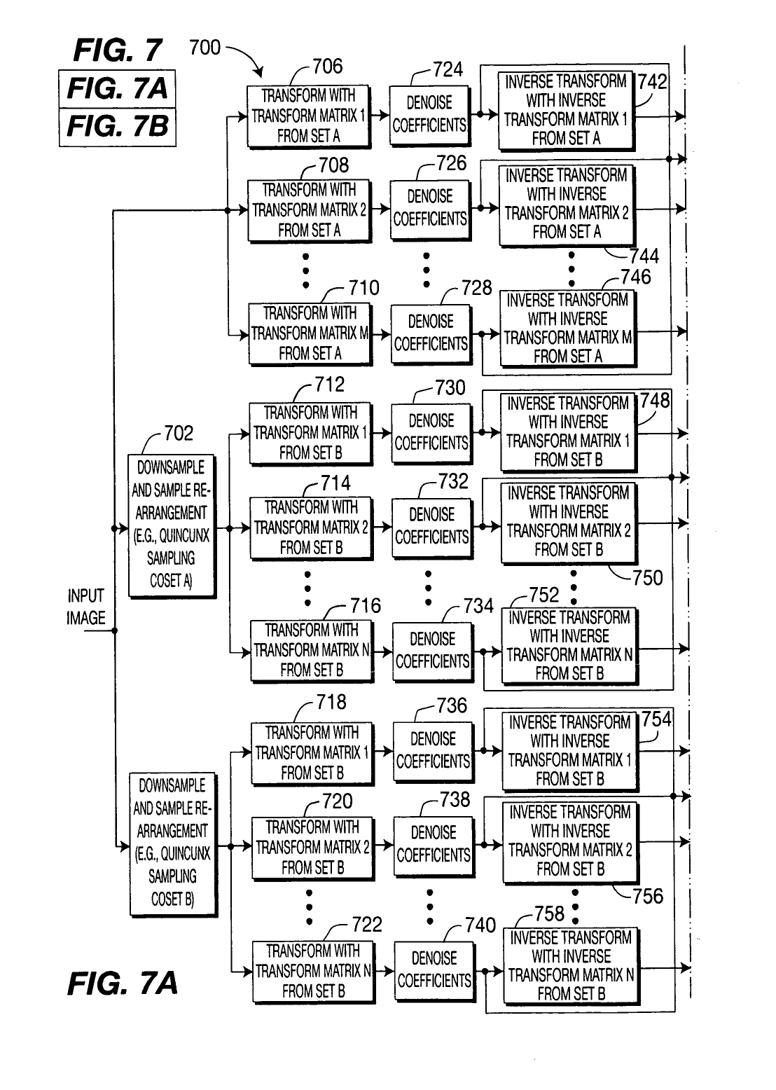

Turning to FIG. 7, an exemplary position adaptive sparsity based filter for pictures with multi-lattice signal transforms is indicated generally by the reference numeral 700.

A downsample and sample arrangement module 702 has an output in signal communication with an input of a transform module (with transform matrix 1 from set B) 712, an input of a transform module (with transform matrix 2 from set B) 714, and an input of a transform module (with transform matrix N from set B) 716.

A downsample and sample rearrangement module 704 has an output in signal communication with an input of a transform module (with transform matrix 1 from set B) 718, an input of a transform module (with transform matrix 2 from set B) 720, and an input of a transform module (with transform matrix N from set B) 722.

An output of the transform module (with transform matrix 1 from set B) 712 is connected in signal communication with an input of a denoise coefficients module 730. An output of the transform module (with transform matrix 2 from set B) 714 is connected in signal communication with an input of a denoise coefficients module 732. An output of the transform module (with transform matrix N from set B) 716 is connected in signal communication with an input of a denoise coefficients module 734.

An output of the transform module (with transform matrix 1 from set B) 718 is connected in signal communication with an input of a denoise coefficients module 736. An output of the transform module (with transform matrix 2 from set B) 720 is connected in signal communication with an input of a denoise coefficients module 738. An output of the transform module (with transform matrix N from set B) 722 is connected in signal communication with an input of a denoise coefficients module 740.

An output of a transform module (with transform matrix 1 from set A) 706 is connected in signal communication with an input of a denoise coefficients module 724. An output of a transform module (with transform matrix 2 from set A) 708 is connected in signal communication with an input of a denoise coefficients module 726. An output of a transform module (with transform matrix M from set A) 710 is connected in signal communication with an input of a denoise coefficients module 728.

An output of the denoise coefficients module 724, an output of the denoise coefficients module 726, and an output of the denoise coefficients module 728 are each connected in signal communication with an input of an inverse transform module (with inverse transform matrix 1 from set A) 742, an input of an inverse transform module (with inverse transform matrix 2 from set A) 744, an input of an inverse transform module (with inverse transform matrix M from set A) 746, and an input of a combination weights computation module 760.

An output of the denoise coefficients module 730, an output of the denoise coefficients module 732, and an output of the denoise coefficients module 734 are each connected in signal communication with an input of an inverse transform module (with inverse transform matrix 1 from set B) 748, an input of an inverse transform module (with inverse transform matrix 2 from set B) 750, an input of an inverse transform module (with inverse transform matrix N from set B) 752, and an input of a combination weights computation module 762.

An output of the denoise coefficients module 736, an output of the denoise coefficients module 738, and an output of the denoise coefficients module 740 are each connected in signal communication with an input of an inverse transform module (with inverse transform matrix 1 from set B) 754, an input of an inverse transform module (with inverse transform matrix 2 from set B) 756, an input of an inverse transform module (with inverse transform matrix N from set B) 758, and an input of a combination weights computation module 764.

An output of the inverse transform module (with inverse transform matrix 1 from set A) 742 is connected in signal communication with a first input of a combiner module 776. An output of the inverse transform module (with inverse transform matrix 2 from set A) 744 is connected in signal communication with a second input of the combiner module 776. An output of the inverse transform module (with inverse transform matrix M from set A) 746 is connected in signal communication with a third input of the combiner module 776.

An output of the inverse transform module (with inverse transform matrix 1 from set B) 748 is connected in signal communication with a first input of an upsample, sample rearrangement and merge cosets module 768. An output of the inverse transform module (with inverse transform matrix 2 from set B) 750 is connected in signal communication with a first input of an upsample, sample rearrangement and merge cosets module 770. An output of the inverse transform module (with inverse transform matrix N from set B) 752 is connected in signal communication with a first input of an upsample, sample rearrangement and merge cosets module 772.

An output of the inverse transform module (with inverse transform matrix 1 from set B) 754 is connected in signal communication with a second input of an upsample, sample rearrangement and merge cosets module 768. An output of the inverse transform module (with inverse transform matrix 2 from set B) 756 is connected in signal communication with a second input of an upsample, sample rearrangement and merge cosets module 770. An output of the inverse transform module (with inverse transform matrix N from set B) 758 is connected in signal communication with a second input of an upsample, sample rearrangement and merge cosets module 772.

An output of the combination weights computation module 760 is connected in signal communication with a first input of a general combination weights computation module 774. An output of the combination weights computation module 762 is connected in signal communication with a first input of an upsample, sample rearrangement and merge cosets module 766. An output of the combination weights computation module 764 is connected in signal communication with a second input of an upsample, sample rearrangement and merge cosets module 766.

An output of the upsample, sample rearrangement and merge cosets module 766 is connected in signal communication with a second input of the general combination weights computation module 774. An output of the general combination weights computation module 774 is connected in signal communication with a fourth input of the combine module 776. An output of the upsample, sample rearrangement and merge cosets module 768 is connected in signal communication with a fifth input of the combiner module 776. An output of the upsample, sample rearrangement and merge cosets module 770 is connected in signal communication with a sixth input of the combiner module 776. An output of the upsample, sample rearrangement and merge cosets module 772 is connected in signal communication with a seventh input of the combiner module 776.

An input of the transform module (with transform matrix 1 from set A) 706, an input of the transform module (with transform matrix 2 from set A) 708, and input of the transform module (with transform matrix M from set A) 710, an input of the downsample and sample arrangement module 702, and an input of the downsample and sample arrangement module 704 are available as input of the filter 700, for receiving an input image. An output of the combiner module 776 is available as an output of the filter 700, for providing an output picture.

Thus, the filter 700 provides processing branches corresponding to the non-downsampled processing of the input data and processing branches corresponding to the lattice-based downsampled processing of the input data. It is to be appreciated that the filter 700 provides a series of processing branches that may or may not be processed in parallel. It is further appreciated that while several different processes are described as being performed by different respective elements of the filter 700, given the teachings of the present principles provided herein, one of ordinary skill in this and related arts will readily appreciate that two or more of such processes may be combined and performed by a single element (for example, a single element common to two or more processing branches, for example, to allow re-use of non-parallel processing of data) and that other modifications may be readily applied thereto, while maintaining the spirit of the present principles. For example, in an embodiment, the combiner module 776 may be implemented outside the filter 700, while maintaining the spirit of the present principles.

Also, the computation of the weights and their use for blending (or fusing) the different filtered images obtained by processing them with the different transforms and sub-samplings, as shown in FIG. 7, may be performed in successive computation steps (as shown in the present embodiment) or may be performed in a single step at the very end by directly taking into account the amount of coefficients used to reconstruct each one of the pixels in each of the sub-sampling lattices and/or transforms.

Given the teachings of the present principles provided herein, one of ordinary skill in this and related arts will contemplate these and other variations of filter 700 (as well as filters 800 and 1300 described herein below), while maintaining the spirit of the present principles. Moreover, one of ordinary skill in this and related arts will contemplate that filters 700, 800, 1300, which use two possibly different sets of redundant transforms A and B, may eventually have sets of transforms A and B that may or may not be the same redundant set of transforms. In the same way, M may or may not equal N.

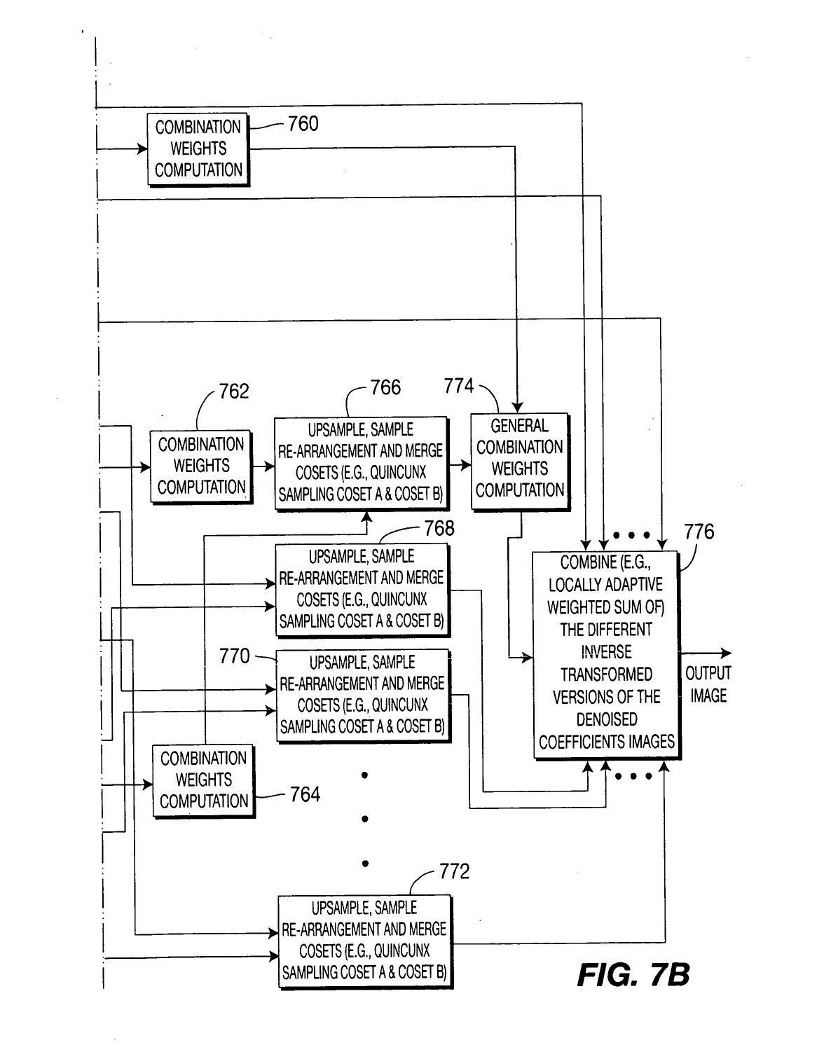

Turning to FIG. 8, another exemplary position adaptive sparsity based filter for pictures with multi-lattice signal transforms is indicated generally by the reference numeral 800. In the filter 800 of FIG. 8, a redundant set of transforms are packed into a single block.

An output of a downsample and sample rearrangement module 802 is connected in signal communication with an input of a forward transform module (with redundant set of transforms B) 808. An output of a downsample and sample rearrangement module 804 is connected in signal communication with an input of a forward transform module (with redundant set of transforms B) 810.

An output of a forward transform module (with redundant set of transforms A) 806 is connected in signal communication with a denoise coefficients module 812. An output of a forward transform module (with redundant set of transforms B) 808 is connected in signal communication with a denoise coefficients module 814. An output of a forward transform module (with redundant set of transforms B) 510 is connected in signal communication with a denoise coefficients module 816.

An output of denoise coefficients module 812 is connected in signal communication with an input of a computation of number of non-zero coefficients affecting each pixel module 826, and an input of an inverse transform module (with redundant set of transforms A) 818. An output of denoise coefficients module 814 is connected in signal communication with an input of a computation of number of non-zero coefficients affecting each pixel module 830, and an input of an inverse transform module (with redundant set of transforms B) 820. An output of denoise coefficients module 816 is connected in signal communication with an input of a computation of number of non-zero coefficients affecting each pixel module 832, and an input of an inverse transform module (with redundant set of transforms B) 822.

An output of the inverse transform module (with redundant set of transforms A) 818 is connected in signal communication with a first input of a combine module 836. An output of the inverse transform module (with redundant set of transforms B) 820 is connected in signal communication with a first input of an upsample, sample rearrangement and merge cosets module 824. An output of the inverse transform module (with redundant set of transforms B) 822 is connected in signal communication with a second input of an upsample, sample rearrangement and merge cosets module 824.

An output of the computation of number of non-zero coefficients affecting each pixel for each transform module 830 is connected in signal communication with a first input of an upsample, sample rearrangement and merge cosets module 828. An output of the computation of number of non-zero coefficients affecting each pixel for each transform module 832 is connected in signal communication with a second input of the upsample, sample rearrangement and merge cosets module 828.

An output of the upsample, sample rearrangement and merge cosets module 828 is connected in signal communication with a first input of a general combination weights computation module 834. An output of the computation of number of non-zero coefficients affecting each pixel 826 is connected in signal communication with a second input of a general combination weights computation module 834. An output of the general combination weights computation module 834 is connected in signal communication with a second input of the combine module 836.

An output of the upsample, sample rearrangement and merge cosets module 824 is connected in signal communication with a third input of a combine module 836.

An input of the forward transform module (with redundant set of transforms A) 806, an input of the downsample and sample rearrangement module 802, and an input of the downsample and sample rearrangement module 804 are each available as input of the filter 800, for receiving an input image. An output of the combine module 836 is available as an output of the filter, for providing an output image.

The filter 800 of FIG. 8, with respect to the filter 700 of FIG. 7, provides a significantly more compact implementation of the algorithm, packing the different transforms involved into a redundant representation of a picture into single box for simplicity and clearness. It is to be appreciated that transformation, denoising, and/or inverse transformation processes may, or may not, be carried out in parallel for each of the transforms included into a redundant set of transforms.

It is to be appreciated that the various processing branches shown in FIGS. 7-5 for filtering picture data, prior to combination weights calculation, may be considered to be version generators in that they generate different versions of an input picture.

As noted above, the present principles are directed to methods and apparatus for in-loop de-artifacting filtering based on multi-lattice sparsity-based filtering.

In accordance with an embodiment of the present principles, a high-performance non-linear filter is proposed that reduces the distortion introduced by the quantization step in the MPEG-4 AVC Standard. Distortion is reduced in both visual and objective measures. The proposed artifact reduction filter reduces, in addition to blocking artifacts, other types of artifacts including, but not limited to, ringing, geometric distortion on edges, texture corruption, and so forth.

In an embodiment, such reduction of artifacts is performed using a high-performance non-linear in-loop filter for de-artifacting decoded video pictures based on the weighted combination of several filtering steps on different sub-lattice samplings of the picture to be filtered. One or more filtering steps are made through the sparse approximation of a lattice sampling of the picture to be filtered. Sparse approximations allow robust separation of true signal components from noise, distortion, and artifacts. This involves the removal of insignificant signal components in a given transformed domain. By allowing sparse approximations to be performed on different sub-sampling lattices of a picture, a transform is generalized in order to handle and/or model a wider range of signal characteristics and/or features. That is, depending on the signal and the sparse filtering technique, adaptation of the filtering is performed since some signal areas may be better filtered on a particular lattice versus another lattice and/or given transform. Indeed, depending on the sub-sampling lattice where a transform is applied, the main directions of decomposition of the transform (e.g., vertical and horizontal in a DCT) may be modified (e.g., with a quincunx sampling the final directions of a DCT transform can be modified to diagonal instead of vertical and horizontal). The final weighting combination step allows for adaptive selection of the best filtered data from the most appropriate sub-lattice sampling and/or transform.

### Oriented Transforms by Transformation of Lattice Sub-Samplings:

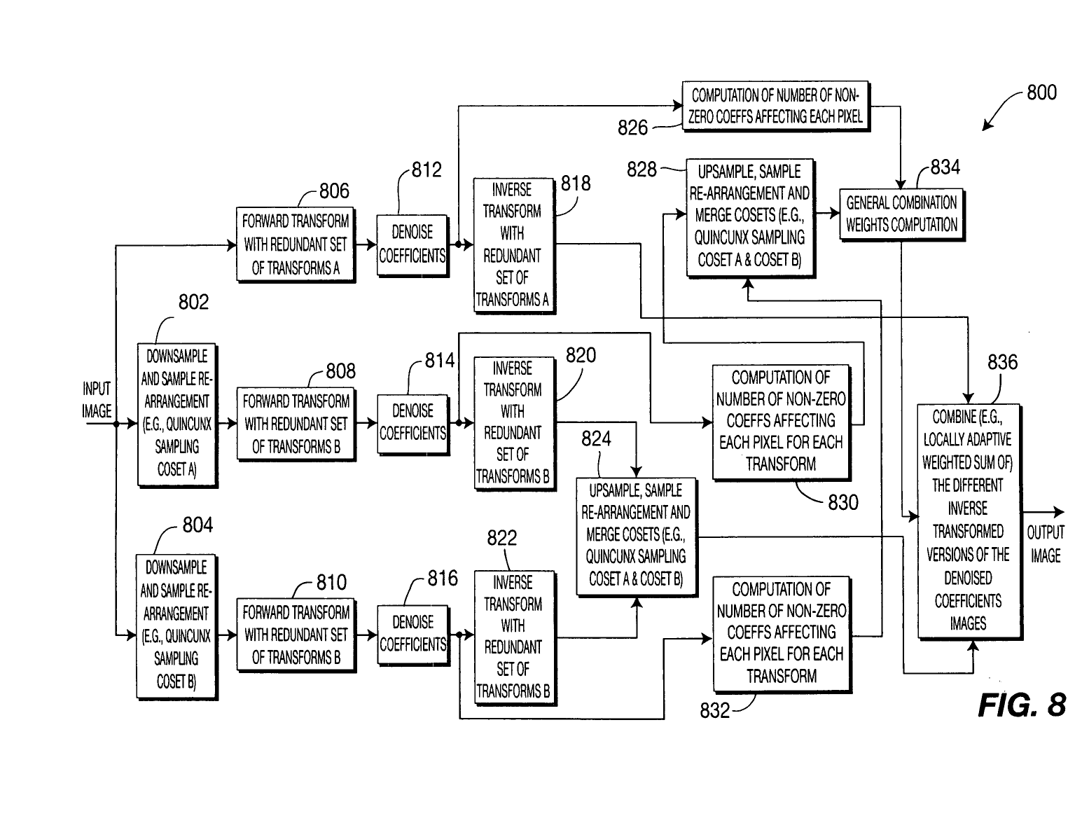

In general, transforms such as the Discrete Cosine Transform (DCT) decompose signals as a sum of primitives or basis functions. These primitives or basis functions have different properties and structural characteristics depending on the transform used. Turning to FIG. 9, Discrete Cosine Transform (DCT) basis functions and their shapes included in a DCT of 8×8 size are indicated generally by the reference numeral 900. As can be observed, basis functions 900 appear to have 2 main structural orientations (or principal directions). There are functions that are mostly vertically oriented, there are functions that are mostly horizontally oriented, and there are functions that are a kind of checkerboard-like mixture of both. These shapes are appropriate for efficient representation of stationary signals as well as of vertically and horizontally shaped signal components. However, parts of signals with oriented properties are not efficiently represented by such a transform. In general, like the DCT example, most transform basis functions have a limited variety of directional components.

One way to modify the directions of decomposition of a transform is to use such a transform in different sub-samplings of a digital image. Indeed, one can decompose 2D sampled images in complementary sub-sets (or cosets) of pixels. These cosets of samples can be generated according to a given sampling pattern. Sub-sampling patterns can be established such that they are oriented. These orientations imposed by the sub-sampling pattern combined with a fixed transform can be used to adapt the directions of decomposition of a transform into a series of desired directions.

In an embodiment of image sub-sampling, one can use integer lattice sub-sampling where the sampling lattice can be represented by means of a non-unique generator matrix. Any lattice Λ, sub-lattice of the cubic integer lattice z², can be represented by a non-unique generator matrix as follows:

$${M}_{Λ} = [ \begin{matrix}{a}_{1} & {b}_{1} \\ {a}_{2} & {b}_{2}\end{matrix} ] = [ \begin{matrix}{d}_{1} \\ {d}_{2}\end{matrix} ] , where {a}_{1} , {a}_{2} , {b}_{1} , {b}_{2} ∈ ℤ .$$

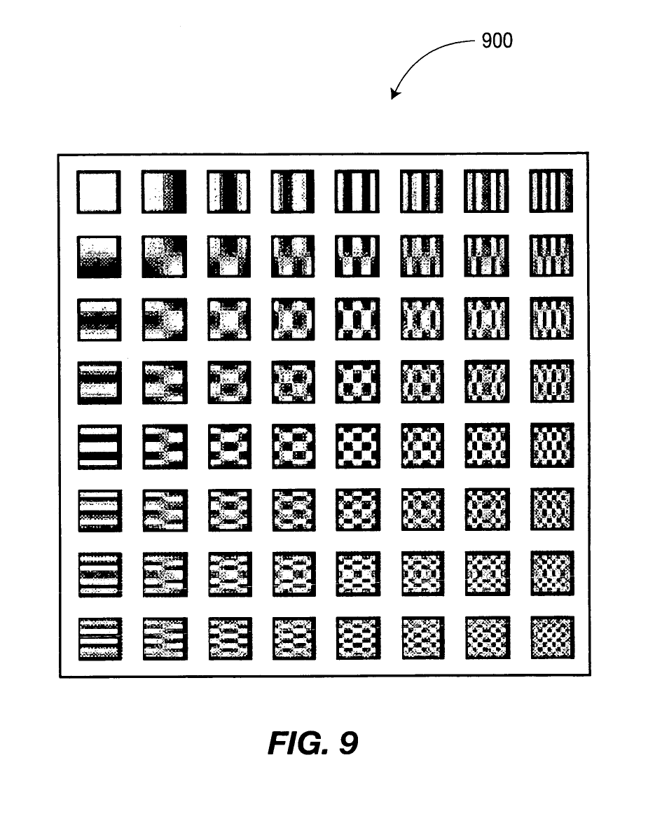

The number of complementary cosets is given by the determinant of the matrix above. Also, d₁d₂ can be related to the main directions of the sampling lattice in a 2D coordinate plane. Turning to FIGS. 10A and 10B, examples of lattice sampling with corresponding lattice sampling matrices, to which the present principles may be applied, is indicated generally by the reference numerals 1000 and 1050, respectively. In FIG. 10A, a quincunx lattice sampling is shown. One of two cosets relating to the quincunx lattice sampling is shown in black (filled-in) dots. The complementary coset is obtained by a 1-shift in the direction of the x/y axis. In FIG. 10B, another directional (or geometric) lattice sampling is shown. Two of the four possible cosets are shown in black and white dots. Arrows depict the main directions of the lattice sampling. One of ordinary skill in this and related arts can appreciate the relationship between the lattice matrices and the main directions (arrows) on the lattice sampling.

Every coset in any of such a sampling lattice is aligned in such a way that can be totally rearranged (e.g., rotated, shrank, and so forth) in a downsampled rectangular grid. This allows for the subsequent application of any transform suitable for a rectangular grid (such as the 2D DCT) on the lattice sub-sampled signal.

The combination of lattice decomposition, lattice re-arrangement, 2D transformation, and the respective set of inverse operations allows for the implementation of 2D signal transformations with arbitrary orientations.

Multiple-Lattice Picture Processing for Orientation Adaptive Filtering:

In an embodiment, the use of at least two samplings of a picture is proposed for adaptive filtering of pictures. In an embodiment, a same filtering strategy such as DCT coefficients thresholding can be reused and generalized for direction adaptive filtering.

One of the at least two lattice samplings/sub-samplings can be, for example, the original sampling grid of a given picture (i.e., no sub-sampling of the picture). In an embodiment, another of the at least two samplings can be the so call “quincunx” lattice sub-sampling. Such a sub-sampling is composed by 2 cosets of samples disposed on diagonally aligned samplings of every other pixel.

In an embodiment, the combination of the at least two lattice samplings/sub-samplings is used in this invention for adaptive filtering, as depicted in FIGS. 11, 5, and 6.

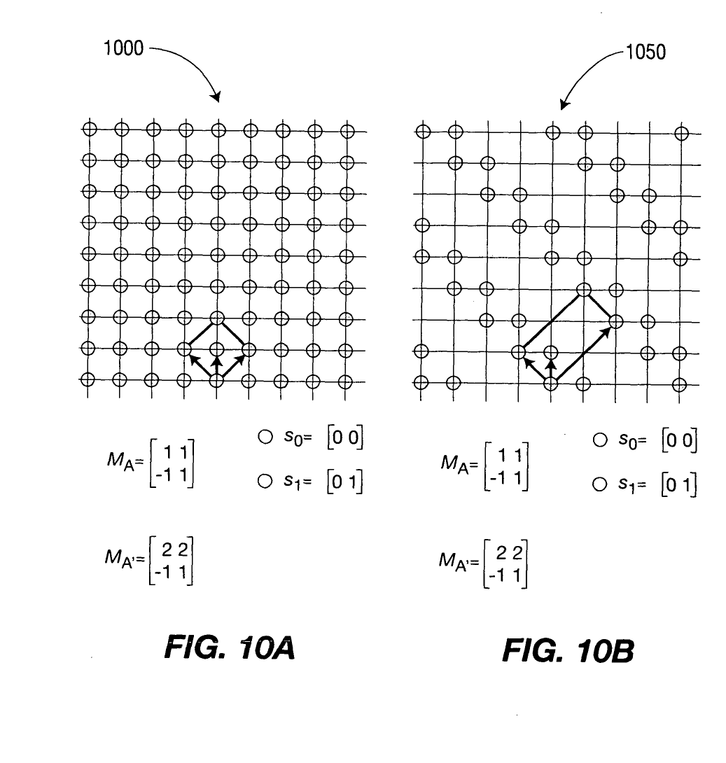

Turning to FIG. 11, an exemplary method for position adaptive sparsity based filtering of pictures with multi-lattice signal transforms is indicated generally by the reference numeral 1100. The method 1100 of FIG. 11 corresponds to the application of sparsity-based filtering in the transformed domain on a series of re-arranged integer lattice sub-samplings of a digital image.

The method 1100 includes a start block 1105 that passes control to a function block 1110. The function block 1110 sets the shape and number of possible families of sub-lattice image decompositions, and passes control to a loop limit block 1115. The loop limit block 1115 performs a loop for every family of (sub-)lattices, using a variable j, and passes control to a function block 1120. The function block 1120 downsamples and splits an image into N sub-lattices according to family of sub-lattices j (the total number of sub-lattices depends on every family j), and passes control to a loop limit block 1125. The loop limit block 1125 performs a loop for every sub-lattice, using a variable k (the total amount depends on the family j), and passes control to a function block 1130. The function block 1130 re-arranges samples (e.g., from arrangement A(j,k) to B), and passes control to a function block 1135. The function block 1135 selects which transforms are allowed to be used for a given family of sub-lattices j, and passes control to a loop limit block 1140. The loop limit block 1140 performs a loop for every allowed transform (selected depending on the sub-lattice family of sub-lattices j), and passes control to a function block 1145. The function block 945 performs a transform with transform matrix i, and passes control to a function block 1150. The function block 1150 denoises the coefficients, and passes control to a function block 1155. The function block 1155 performs an inverse transform with inverse transform matrix i, and passes control to a loop limit block 1160. The loop limit block 1160 ends the loop over each value of variable i, and passes control to a function block 1165. The function block 1165 re-arranges samples (from arrangement B to A(j,k)), and passes control to a loop limit block 1170. The loop limit block 1170 ends the loop over each value of variable k, and passes control to a function block 1175. The function block 1175 upsamples and merges sub-lattices according to family of sub-lattices j, and passes control to a loop limit block 1180. The loop limit block 1180 ends the loop over each value of variable j, and passes control to a function block 1185. The function block 1185 combines (e.g., locally adaptive weighted sum of) the different inverse transformed versions of the denoised coefficients images, and passes control to an end block 1199.

With respect to FIG. 11, it can be seen that in an embodiment, a series of filtered pictures are generated by the use of transformed domain filtering that, in turn, uses different transforms in different sub-samplings of the picture. The final filtered image is computed as the locally adaptive weighted sum of each of the filtered pictures.

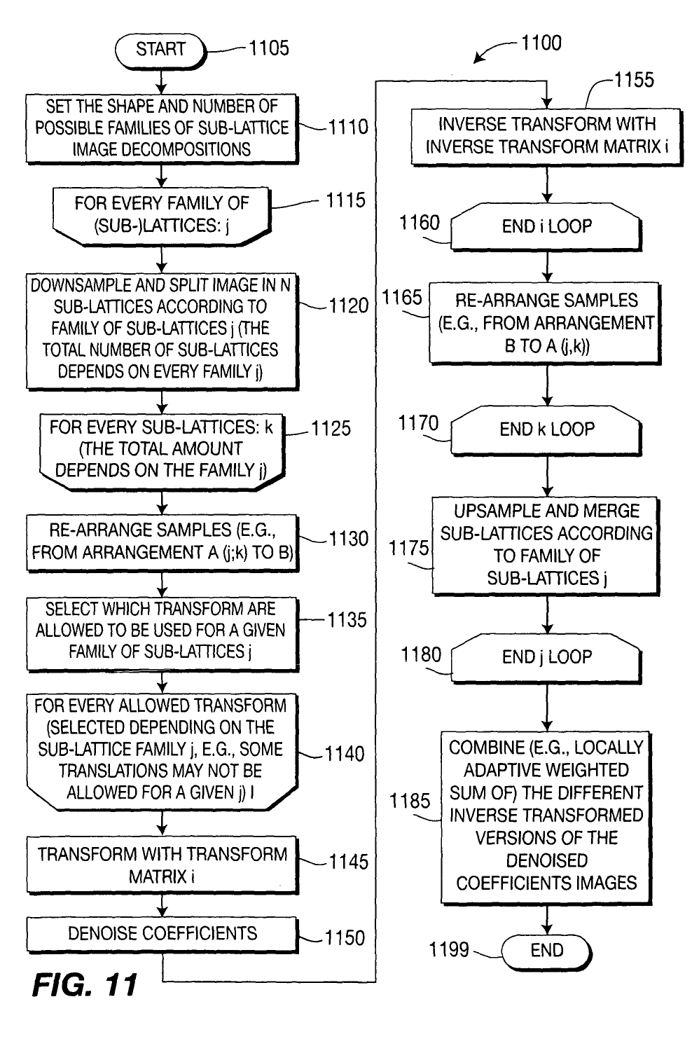

In an embodiment, the set of transforms applied to any re-arranged integer lattice sub-sampling of a digital image is formed by all the possible translations of a 2D DCT. This implies that there are a total of 16 possible translations of a 4×4 DCT for the block based partitioning of a picture for block transform. In the same way, 64 would be the total number of possible translations of an 8×8 DCT. An example of this can be seen in FIGS. 12A-12D. Turning to FIGS. 12A-12D, exemplary possible translations of block partitioning for DCT transformation of an image is indicated generally by the reference numerals 1210, 1220, 1230, and 1240, respectively. FIGS. 12A-12D respectively show one of four of the 16 possible translations of a 4×4 DCT transform. Incomplete boundary blocks, smaller than the transform size, can be virtually extended for example using some padding or image extensions. Partitions that are smaller than the transform size, on the boundaries of the picture, can be virtually extended by means of padding or some sort of picture extension. This allows for the use of the same transform size in all the image blocks. FIG. 11 indicates that such a set of translated DCTs are applied in the present example to each of the sub-lattices (each of the 2 quincunx cosets in the present example).

In an embodiment, the filtering process can be performed at the core of the transformation stage by thresholding, selecting and/or weighting the transformed coefficients of every translated transform of every lattice sub-sampling. The threshold value used for such a purpose may depend on, but is not limited to, one or more of the following: local signal characteristics, user selection, local statistics, global statistics, local noise, global noise, local distortion, global distortion, statistics of signal components pre-designated for removal, and characteristics of signal components pre-designated for removal. After the thresholding step, every transformed and/or translated lattice sub-sampling is inverse transformed. Every set of complementary cosets are rotated back to their original sampling scheme, upsampled and merged in order to recover the original sampling grid of the original picture. In the particular case where transforms are directly applied to the original sampling of the picture, no rotation, upsampling and sample merging is required.

Weight Generation for Fusing the Multiple-Lattice Multiple-Transform Set of De-Artifacted Pictures Estimates:

Finally, according to FIG. 11, all the different filtered pictures are blended into one picture by the weighted addition of all of them. In one embodiment, this is performed in the following way. Let I′ᵢ be each of the different images filtered by thresholding, where each I′ᵢ may correspond to any of the reconstructed pictures after thresholding of a certain translation of a DCT (or MPEG-4 AVC Standard integer transform) on pictures that may or may not have undergone lattice sub-sampling during the filtering process. Let Wᵢ be a picture of weights where every pixel includes a weight associated to its co-located pixel in I′ᵢ. Then the final estimate I′_{final} is obtained as follows:

$${I}_{final}^{′} ( x , y ) = {\sum }_{I} {I}_{i}^{′} ( x , y ) \cdot {W}_{i} ( x , y ) ,$$

where x and y represent the spatial coordinates.

In an embodiment, Wᵢ(x, y) can be computed in a manner such that when used within the previous equation, at every location, the I′ᵢ(x, y) having a local sparser representation in the transformed domain has a greater weight. This comes from the presumption that the I′ᵢ(x, y) obtained from the sparser of the transforms after thresholding includes the lowest amount of noise/distortion. In an embodiment, Wᵢ(x, y) matrices are generated for every I′ᵢ(x, y) (those obtained from the non-sub-sampled filterings and for lattice sub-sampled based filtering). Wᵢ(x,y)corresponding to I′ᵢ(x, y) that have undergone a lattice sub-sampling procedure are obtained by means of the generation of an independent W_{i,coset(j)}(x, y) for every filtered sub-sampled image (i.e., before the procedure of rotation, upsampling, and merging), and then the different W_{i,coset(j)}(x,y) corresponding to a I′ᵢ(x, y) are rotated, up-sampled and merged in the same way as it is done to recompose I′ᵢ(x, y) from its complementary sub-sampled components. Hence, in an example, every filtered image having undergone a quincunx sub-sampling during the filtering process would have 2 weight sub-sampled matrices. These can then be rotated, upsampled and merged into one single weighting matrix to be used with its corresponding I′ᵢ(x, y).

In an embodiment, the generation of each W_{i,coset(j)}(x,y) is performed in the same way as for Wᵢ(x,y). Every pixel is assigned a weight that is derived from the amount of non-zero coefficients of the block transform where such a pixel is included. In an example, the weights of W_{i,coset(j)}(x,y) (and Wᵢ(x, y) as well) can be computed for every pixel such that they are inversely proportional to the amount of non-zero coefficients within the block transform that include each of the pixels. According to this approach, weights in Wᵢ(x, y) have the same block structure as the transforms used to generate I′ᵢ(x, y).

Transform Set Selection for a Sampling/Sub-Sampling Lattice:

In an embodiment, where the DCT and/or the integer MPEG-4 AVC Standard block transform are used within the sparsity based de-artifacting in-loop filter, the transform used in the filtering step is closely similar (or equal) to the transform used to code the residual signal after the prediction step in the MPEG-4 AVC Standard. Since the quantization error introduced into the coded signal is sometimes under the form of a reduction of the number of coefficients available for reconstruction, this reduction of coefficients confuses the measure of signal sparsity performed in the generation of weights in the first prior art approach. This makes quantization noise affect the weights generation, which then affects the proper weighting of the best I′ᵢ in some locations, making still visible some blocky artifacts after filtering.

As stated above, one presumption relating to sparsity-based filtering is that that the real signal has a sparse representation/approximation in at least one of the transforms and sub-sampling lattices and that the artifact component of the signal does not have a sparse representation/approximation in any of the transforms and sub-sampling lattices. In other words, one expects that the real (desired signal) can be well approximated within a sub-space of basis functions, while the artifact signal is mostly excluded from that sub-space, or exists with a low presence.

When using the same family of transforms for filtering and for residual coding, for the filtering transform blocks that are aligned or mostly aligned (e.g., 1 pixel of miss-alignment in at least one of the x and y directions) with the coding transform blocks, it may happen that the quantization noise and/or artifact introduced in the signal falls mostly within the same sub-space of basis functions as the signal itself. In that case, the denoising algorithm more easily confuses the signal and the noise (i.e., the noise is not independent and identically distributed (i.i.d.) with respect to the signal), and is usually unable to separate them. Let us consider the following representation by the MPEG-4 AVC Standard of the original signal I_{orig}(x, y) in terms of the prediction I_{pred}(x, y) and the transformed residual signal Iᵣₑₛ(x, y)=I_{orig}(x, y)−I_{pred}(x, y) using an orthonormal transform (i.e., MPEG-4 AVC integer transform in this case) as follows:

$${I}_{orig} ( x , y ) = {I}_{pred} ( x , y ) + {\sum }_{j ∈ J} 〈 {I}_{res} ( x , y ) , {g}_{j} ( x , y ) 〉 \cdot {g}_{j} ( x , y ) ,$$

where gⱼ(x, y): jεJ are the basis functions of the transform.

In the quantization step, the coefficients of the transform: [symbol] Iᵣₑₛ(x, y), gⱼ(x, y)| [symbol] are quantized to a limited set of values, some of the coefficients being simply zeroed. In such a case, the encoded signal is as follows:

$$I ( x , y ) = {I}_{pred} ( x , y ) + {\sum }_{j ∈ K} quant ( 〈 {I}_{res} ( x , y ) , {g}_{j} ( x , y ) 〉 ) \cdot {g}_{j} ( x , y ) ,$$

where quant(·) represents the quantization operation, and jεK indicates that the set of basis functions with non-zero coefficients may be smaller than when no quantization is applied (i.e. card(K)≦card(J), where card(·) indicates a measure of cardinality). In this case, the distortion noise is as follows:

$$Artifact\_signal ( x , y ) = - {\sum }_{j ∈ J} ( \begin{matrix}〈 {I}_{res} ( x , y ) , {g}_{j} ( x , y ) 〉 - \\ quant ( 〈 {I}_{res} ( x , y ) , {g}_{j} ( x , y ) 〉 )\end{matrix} ) \cdot {g}_{j} ( x , y )$$

$$i . e . , I ( x , y ) = {I}_{orig} ( x , y ) + Artifact\_signal ( x , y ) .$$

The reduction in the number of non-zero coefficients of the residual due to the quantization may, for example, also influence the number of non-zero coefficients in I(x, y), leading to a signal with sparser representation than I_{orig}(x, y). When the denoising algorithm is applied, the transforms in the non sub-sample lattice, which have a higher alignment with the block division used by the coding transform, will probably find that the signal they represent is more compact in terms of coefficients. According to a weights generation method, as described above, the filtered pictures issuing from those “aligned” transforms, will be favored, and artifacts will persist within the signal. This is a problem since such filtering steps using “aligned” or significantly “aligned” (e.g., 1 pixel of misalignment in at least one of the x and y directions) are not able to separate the “actual” signal from the artifact signal.

Based on this, the set of transforms used in each of the sampled lattices should be adapted such that there are no filtering transforms “aligned” or significantly “aligned” with the coding transforms. In an embodiment, this affects the transforms used in the non-subsampled lattice (i.e., the straight application of the translated transforms to the distorted picture for filtering).

In an embodiment, we consider the use of various translations (or a set of translations) of the DCT (and/or MPEG-4 AVC Standard integer transform) for filtering purposes. When 4×4 transforms are used, 16 possible translations can be considered to be part of the set of matrices used. If we presume the translation (0,0) to be the block partition of the MPEG-4 AVC Standard transformation step for coding the residual then, for example, those translations that are aligned in at least one of the block axis may have to be removed. In an embodiment, those transforms which are the following translations of the DCT (and/or MPEG-4 AVC Standard integer transform) are removed from the set of used transformations on the non-subsampled lattice of the picture: (0,0); (0,1); (0,2); (0,3); (1,0); (2,0); and (3,0).

This means that only those translations of a transform that are at least translated in both of the block axis are actually used in the present example. For example, the translation may be obtained from the set of possible translations shown in FIGS. 12A-12D, only the 3rd (bottom-left, shown in FIG. 12C) would be considered.

In an embodiment, all possible translations of the DCT (or MPEG-4 AVC Standard integer transform) are considered for the transformation on the quincunx sampling.

In-Loop Filter Adaptation:

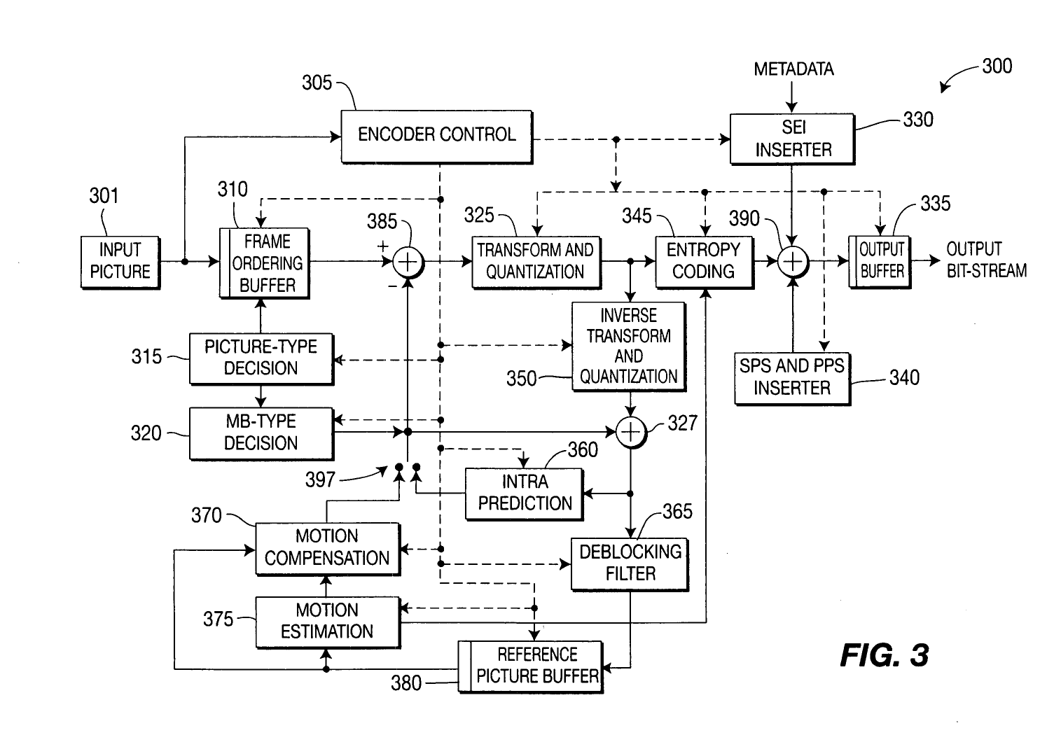

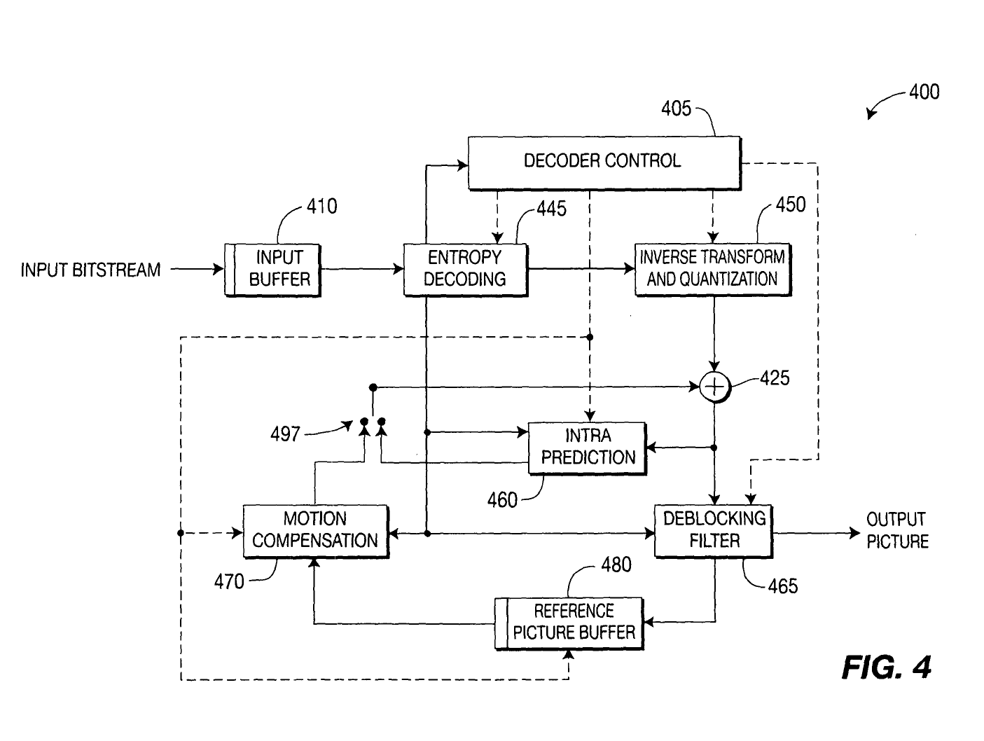

The proposed de-artifacting algorithm described herein may be embedded for use within an in-loop de-artifacting filter. The proposed in-loop de-artifacting filter may be embedded within the loop of a hybrid video encoder/decoder, or separate implementations of an encoder and/or decoder. The video encoder/decoder can be, for example an MPEG-4 AVC Standard video encoder/decoder. FIGS. 5 and 6 show exemplary embodiments, where in-loop de-artifacting filters have been inserted within an MPEG-4 AVC Standard encoder and decoder, respectively, in place of the de-blocking filter (see FIGS. 3 and 4 for comparison).

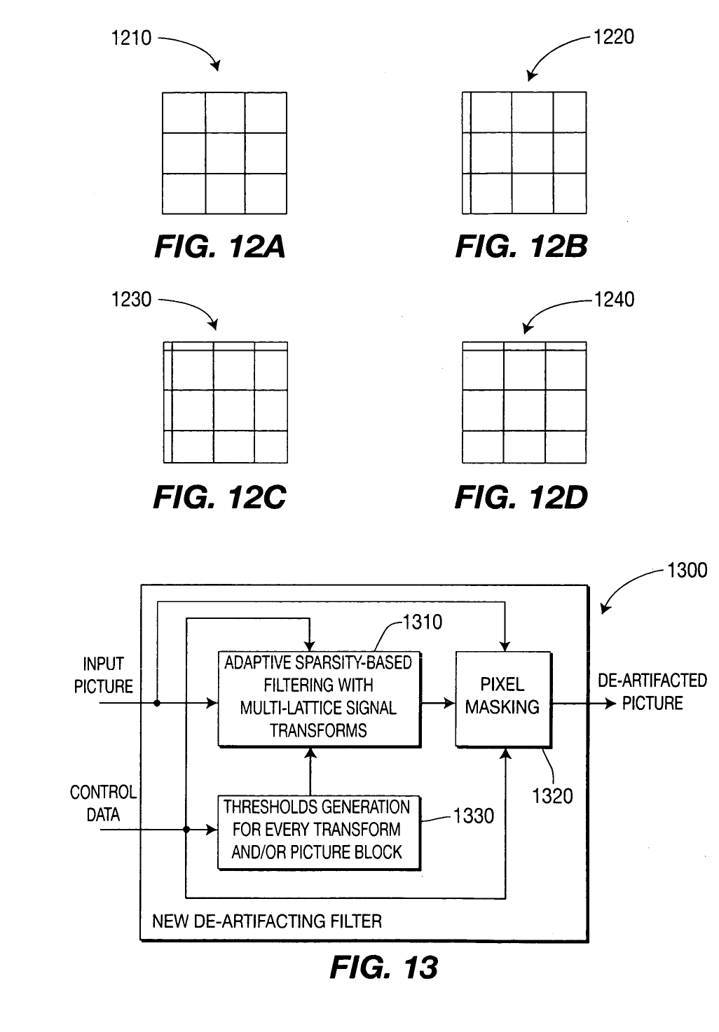

Turning to FIG. 13, an exemplary in-loop de-artifacting filter based on multi-lattice sparsity-based filtering is indicated generally by the reference numeral 1300.

The filter 1300 includes adaptive sparsity-based filter (with multi-lattice signal transforms) 1310 having an output connected in signal communication with a first input of a pixel masking module 1320. An output of a threshold generator 1330 is connected in signal communication with a first input of the adaptive sparsity-based filter 1310.

A second input of the adaptive sparsity-based filter 1310 and a second input of the pixel masking module 1320 are available as inputs of the filter 1300, for receiving an input picture. An input of the threshold generator 1330, a third input of the adaptive sparsity-based filter 1310, and a third input of the pixel masking module 1320 are available as inputs of the filter 1300, for receiving control data. An output of the pixel masking module 1320 is available as an output of the filter 1300, for outputting a de-artifacted picture.

The threshold generator 1330 adaptively computes threshold values for each of the block transforms (for example, for each block in each translation and/or lattice sub-sampling). These thresholds depend on at least one of a block quality parameter (e.g., using the quantization parameter (QP) in the MPEG-4 AVC Standard), block mode, prediction data (intra prediction mode, motion data, and so forth), transform coefficients, local signal structure and/or local signal statistics. In an embodiment, the threshold for de-artifacting per block transform can be made locally dependent on QP and on a local filtering strength parameter akin to the de-blocking filtering strength of the MPEG-4 AVC Standard.

The pixel masking module 1320 depends on a function of at least one of a block quality parameter (e.g., QP in the MPEG-4 AVC Standard), block mode, prediction data (intra prediction mode, motion data, and so forth), transform coefficients, local signal structure and/or local signal statistics, determines whether a pixel of the output picture is left unfiltered (hence, the original pre-filter pixel is used, or the filtered pixel is used). This is of special use in coding modes where no transform coefficients are transmitted, or where no de-artifacting filtering is desired. An example of such a mode is the SKIP mode in the MPEG-4 AVC Standard.

The threshold generator 1330 and the pixel masking module 1320 both use information from the coding control unit and decoding control units 505 and 605 shown in FIGS. 5 and 6, respectively.

As shown in FIGS. 5 and 6, the coding control unit 505 and decoding control unit 605 are modified in order to accommodate the control of the proposed in-loop de-artifacting filter. This has a consequence on the possible requirement of block level syntax and high level syntax for setting, configuring and adapting the in-loop de-artifacting filter for the most efficient operation. Indeed, the de-artifacting filter may be switched on or off for encoding a video sequence. Also, several custom settings may be desirable in order to have some control on the default functioning of this. For this purpose, several syntax fields may be defined at different levels including, but not limited to, the following: sequence parameter level; picture parameter level; slice level; and/or block level. In the following, several exemplary block and/or high syntax level fields are exposed with their corresponding coding structure described in TABLES 1-3.

TABLE 1 shows exemplary picture parameter set syntax data for an in-loop de-artifacting filter based on multi-lattice sparsity-based filtering. TABLE 2 shows exemplary slice header syntax data for an in-loop de-artifacting filter based on multi-lattice sparsity-based filtering. TABLE 3 shows exemplary macroblock syntax data for an in-loop de-artifacting filter based on multi-lattice sparsity-based filtering.

sparse_filter_control_present_flag equal to 1 specifies that a set of syntax elements controlling the characteristics of the sparse denoising filter is present in the slice header sparse_filter_control_present_flag equal to 0, it specifies that a set of syntax elements controlling the characteristics of the sparse denoising filter is not present in the slice header and their inferred values are in effect.

enable_selection_of_sparse_threshold,

enable_selection_of_transform_type,

enable_selection_of_adaptive_weighting_type,

enable_selection_of_set_of subsampling_lattices,

enable_selection_of_transform_sets are high level syntax values that can be, for example, either located at the sequence parameter set and/or picture parameter set levels. In an embodiment, these values enable the possibility to change the default values for the threshold, transform type, weighting type, set of subsampling lattices and/or the transform sets for each lattice at the slice level.

disable_sparse_filter_flag specifies whether the operation of the sparse denoising filter shall be disabled. When disable_sparse_filter_flag is not present in the slice header, disable_sparse_filter_flag shall be inferred to be equal to 0.

sparse_threshold specifies the value of threshold used in sparse denoising. When sparse_threshold is not present in the slice header, the default value derived based on slice QP is used.

sparse_transform_type specifies the type of the transform used in sparse denoising. sparse_transform_type equal to 0 specifies that a 4×4 transform is used. sparse_transform_type equal to 1 specifies that a 8×8 transform is used.

adaptive_weighting_type specifies the type of weighting used in sparse denoising. For example, adaptive_weighting_type equal to 0 may specify that sparsity weighting is used. For instance, adaptive_weighting_type equal to 1 may specify that average weighting is used.

set_of_subsampling_lattices specifies how many and which are the subsampling lattices used for decomposing a picture previous to its transformation.

enable_macroblock_threshold_adaptation_flag specifies whether the threshold value shall be corrected and modified at the macroblock level.

transform_set_type[i] specifies, when necessary, the set of transforms used in each lattice sampling. For example, in an embodiment, it can be used to code the set of transform translations used for in-loop filtering in each of the lattice samplings if different settings from the default are needed.

sparse_threshold_delta specifies the new threshold value to be used in the block transforms substantially overlapping (e.g., at least 50% of) the macroblock. The new threshold value may be specified in terms of its full value, difference with respect to the previous macroblock threshold and/or in terms of the difference with respect to the default threshold value that may be set up depending on the QP, transform coefficients coded and/or block coding mode.

TABLE 1

| | | |
|---|---|---|
| pic_parameter_set_rbsp( ) { | C | Descriptor |

...

| | | |
|---|---|---|
| sparse_filter_control_present_flag | 1 | u(1) |

If(sparse_filter_control_present_flag){

| | | |
|---|---|---|
| enable_selection_of_sparse_threshold | 1 | u(1) |
| enable_selection_of_transform_type | 1 | u(1) |
| enable_selection_of_adaptive_weighting_type | 1 | u(1) |
| enable_selection_of_transform_sets | 1 | u(1) |
| enable_selection_of_set_of_subsampling_lattices | 1 | u(1) |

}
...
}

TABLE 2

| | | |
|---|---|---|
| slice_header( ) { | C | Descriptor |

...
if( sparse_filter_control_present_flag ) {

| | | |
|---|---|---|
| disable_sparse_filter_flag | 2 | u(1) |
| if( disable_sparse_filter_flag != 1 ) { | | |

| | | |
|---|---|---|
| if(enable_selection_of _sparse_threshold) sparse_threshold | 2 | u(v) |
| if (enable_selection_of _transform_type) sparse_transform_type | 2 | u(v) |
| if(enable_selection_of_adaptive_weighting_type) | 2 | u(v) |

adaptive weighting type

if(enable_selection_of_set_of_subsampling_lattices){

| | | |
|---|---|---|
| set_of_subsampling_lattices | 2 | u(v) |

}
if(enable_selection_of_transform_sets){

for(i=0;i<Number_of_subsampling_lattices;i++){

| | | |
|---|---|---|
| transform_set_type[i] | 2 | u(v) |

}

}
if(enable_selection_of_set_of_subsampling_lattices){

| | | |
|---|---|---|
| enable_macroblock_threshold_adaptation_flag | 2 | u(1) |

}

}

}
...
}

TABLE 3

| | | |
|---|---|---|
| macroblock_data( ) { | C | Descriptor |

...

if( enable_macroblock_threshold_adaptation_flag == 1 ) {

| | | |
|---|---|---|
| sparse_threshold_delta | 2 | u(v) |

}

...
}

A description will now be given of some of the many attendant advantages/features of the present invention, some of which have been mentioned above. For example, one advantage/feature is an apparatus having an encoder for encoding picture data for a picture. The encoder includes an in-loop de-artifacting filter for de-artifacting the picture data to output an adaptive weighted combination of at least two filtered versions of the picture. The picture data includes at least one sub-sampling of the picture.

Another advantage/feature is the apparatus having the encoder with the in-loop de-artifacting filter as described above, wherein the picture data is transformed into coefficients, and the in-loop de-artifacting filter filters the coefficients in a transformed domain based on signal sparsity.

Yet another advantage/feature is the apparatus having the encoder with the in-loop de-artifacting filter that filters the coefficients in the transformed domain based on signal sparsity as described above, wherein the coefficients are filtered in the transformed domain using at least one threshold that is locally adaptive depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

Still another advantage/feature is the apparatus having the encoder with the in-loop de-artifacting filter as described above, wherein application of the in-loop de-artifacting filter is selectively enabled or disabled locally with respect to the encoder depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

Moreover, another advantage/feature is the apparatus having the encoder with the in-loop de-artifacting filter as described above, wherein application of the in-loop de-artifacting filter is selectively enabled or disabled using a high level syntax element, and wherein the in-loop de-artifacting filter is subjected to at least one of adaptation, modification, enablement, and disablement by said encoder, and wherein the adaptation, the modification, the enablement, and the disablement are signaled to a corresponding decoder using at least one of the high level syntax element and a block level syntax element.

Further, another advantage/feature is the apparatus having the encoder with the in-loop de-artifacting filter as described above, wherein the in-loop de-artifacting filter includes a version generator, a weights calculator, and a combiner. The version generator is for generating the at least two filtered versions of the picture. The weights calculator is for calculating the weights for each of the at least two filtered versions of the picture. The combiner is for adaptively calculating the adaptive weighted combination of the at least two filtered versions of the picture.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an encoder for encoding picture data for a picture,
wherein the encoder includes:
an in-loop de-artifacting filter for de-artifacting the picture data to output an adaptive weighted combination of at least two filtered versions of the picture, the picture data including at least one sub-sampling of the picture.

2. The apparatus of claim 1, wherein the picture data is transformed into coefficients, and said in-loop de-artifacting filter filters the coefficients in a transformed domain based on signal sparsity.

3. The apparatus of claim 2, wherein the coefficients are filtered in the transformed domain using at least one threshold that is locally adaptive depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

4. The apparatus of claim 1, wherein application of said in-loop de-artifacting filter is selectively enabled or disabled locally with respect to said encoder depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

5. The apparatus of claim 1, wherein application of said in-loop de-artifacting filter is selectively enabled or disabled using a high level syntax element, and wherein said in-loop de-artifacting filter is subjected to at least one of adaptation, modification, enablement, and disablement by said encoder, and wherein the adaptation, the modification, the enablement, and the disablement are signaled to a corresponding decoder using at least one of the high level syntax element and a block level syntax element.

6. The apparatus of claim 1, wherein said in-loop de-artifacting filter comprises:
a version generator for generating the at least two filtered versions of the picture;
a weights calculator for calculating the weights for each of the at least two filtered versions of the picture; and
a combiner for adaptively calculating the adaptive weighted combination of the at least two filtered versions of the picture.

7. A method, comprising:
encoding picture data for a picture,
wherein said encoding step comprises:
in-loop de-artifact filtering the picture data to output an adaptive weighted combination of at least two filtered versions of the picture, the picture data including at least one sub-sampling of the picture.

8. The method of claim 7, wherein the picture data is transformed into coefficients, and said in-loop de-artifact filtering step filters the coefficients in a transformed domain based on signal sparsity.

9. The method of claim 8, wherein the coefficients are filtered in the transformed domain using at least one threshold that is locally adaptive depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

10. The method of claim 7, wherein application of said in-loop de-artifact filtering step is selectively enabled or disabled locally with respect to an encoder performing the method depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

11. The method of claim 7, wherein application of said in-loop de-artifact filtering is selectively enabled or disabled using a high level syntax element, and wherein said in-loop de-artifact filtering step is subjected to at least one of adaptation, modification, enablement, and disablement by an encoder performing the method, and wherein the adaptation, the modification, the enablement, and the disablement are signaled to a corresponding decoder using at least one of the high level syntax element and a block level syntax element.

12. The method of claim 7, wherein said in-loop de-artifact filtering step comprises:
generating the at least two filtered versions of the picture;
calculating the weights for each of the at least two filtered versions of the picture; and
adaptively calculating the adaptive weighted combination of the at least two filtered versions of the picture.

13. An apparatus, comprising:
a decoder for decoding picture data for a picture,
wherein the decoder includes:
an in-loop de-artifacting filter for de-artifacting the picture data to output an adaptive weighted combination of at least two filtered versions of the picture, the picture data including at least one sub-sampling of the picture.

14. The apparatus of claim 13, wherein the picture data is transformed into coefficients, and said in-loop de-artifacting filter filters the coefficients in a transformed domain based on signal sparsity.

15. The apparatus of claim 14, wherein the coefficients are filtered in the transformed domain using at least one threshold that is locally adaptive depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

16. The apparatus of claim 13, wherein application of said in-loop de-artifacting filter is selectively enabled or disabled locally with respect to said decoder depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

17. The apparatus of claim 13, wherein application of said in-loop de-artifacting filter is selectively enabled or disabled using a high level syntax element, and wherein said in-loop de-artifacting filter is subjected to at least one of adaptation, modification, enablement, and disablement by an encoder, and wherein the adaptation, the modification, the enablement, and the disablement are determined by said decoder using at least one of the high level syntax element and a block level syntax element.

18. The apparatus of claim 13, wherein said in-loop de-artifacting filter comprises:
a version generator for generating the at least two filtered versions of the picture;
a weights calculator for calculating the weights for each of the at least two filtered versions of the picture; and
a combiner for adaptively calculating the adaptive weighted combination of the at least two filtered versions of the picture.

19. A method, comprising:
decoding picture data for a picture,
wherein the decoding step includes:
in-loop de-artifact filtering the decoded picture data to output an adaptive weighted combination of at least two filtered versions of the picture, the picture data including at least one sub-sampling of the picture.

20. The method of claim 19, wherein the picture data is transformed into coefficients, and said in-loop de-artifact filtering step filters the coefficients in a transformed domain based on signal sparsity.

21. The method of claim 20, wherein the coefficients are filtered in the transformed domain using at least one threshold that is locally adaptive depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

22. The method of claim 19, wherein said in-loop de-artifact filtering step is selectively enabled or disabled locally with respect to a decoder performing the method depending on at least one of user selection, local signal characteristics, global signal characteristics, local signal statistics, global signal statistics, local distortion, global distortion, local noise, global noise, statistics of signal components pre-designated for removal, characteristics of the signal components pre-designated for removal, block coding mode, and the coefficients.

23. The method of claim 19, wherein application of said in-loop de-artifact filtering step is selectively enabled or disabled using a high level syntax element, and wherein said in-loop de-artifact filtering step is subjected to at least one of adaptation, modification, enablement, and disablement by an encoder, and wherein the adaptation, the modification, the enablement, and the disablement are determined by a decoder performing the method using at least one of the high level syntax element and a block level syntax element.

24. The method of claim 19, wherein said in-loop de-artifact filtering step comprises:
generating the at least two filtered versions of the picture;
calculating the weights for each of the at least two filtered versions of the picture; and
adaptively calculating the adaptive weighted combination of the at least two filtered versions of the picture.

25. A computer-readable media having video signal data encoded thereupon, comprising:
an adaptive weighted combination of at least two filtered versions of a picture, generated by de-artifact filtering picture data for the picture, the picture data including at least one sub-sampling of the picture.
